(19) United States
(12) Patent Application Publication
(10) Pub. No.: US 2002/0103691 A1
(43) Pub. Date: Aug. 1, 2002

(54) System and method for automated scheduling of temporary medical professionals

(76) Inventor: Ronald A. Smith, Diamond Bar, CA (US)

Correspondence Address: Ronald A. Smith, Suite 303, 556 N. Diamond Bar Blvd., Diamond Bar, CA, 91765, US

(21) Appl. No.: 09/774,510

(22) Filed: Jan. 31, 2001

(51) Int. Cl. G06F 17/60

(52) U.S. Cl. 705/9

(57) ABSTRACT

A system wherein computer software is used to facilitate the scheduling of temporary medical professionals between registries and/or individuals and the ordering hospitals or medical facilities. The system contains a permanent storage area containing the database of available staffers and user hospitals. The hospital may place an order into the system on short notice for a particular shift and the system sorts through the database to identify matches. The matches are then automatically notified electronically on a continuing basis until a staffer has accepted the assignment, at which time the notification process ceases and further acceptance is locked out. The hospital is notified electronically of the identity of the accepting staffer. Invoicing for the staffer's services is automatic.

### CROSS REFERENCE TO RELATED APPLICATIONS

Not applicable.

### BACKGROUND—FIELD OF INVENTION

This invention relates to scheduling of temporary medical professionals for work at hospitals and other facilities where they are not regularly employed, and automates the scheduling system between medical registries and medical facilities.

### BACKGROUND—DESCRIPTION OF PRIOR ART

Thousands of medical professionals, including but not limited to doctors, nurses and respiratory therapists, are assigned each day to temporary work at hospitals and medical facilities throughout the world, usually through medical registries. A medical registry functions much like a temporary employment agency, but confines its services to placing medical personnel in temporary positions, often on very short notice.

Inventors have often addressed the need for scheduling systems, but these were usually confined to use within a given organization or company and did not allow the customer to interface with more than one supplier or vendor at a time. Examples of prior art that involves in-house scheduling are: U.S. Pat. No. 5,970,466, which schedules doctor's appointments within an office grouping; U.S. Pat. No. 5,615,121, which schedules customer service calls within a company in the most efficient manner; and U.S. Pat. No. 5,848,395, which books outside service routes in the most efficient manner.

Inventors have also recently looked at interactive scheduling, wherein a worker may accept or refuse a work assignment based on his availability, as in U.S. Pat. No. 5,907,829, or indicate in a database his or her availability and/or preference for a work assignment, as in U.S. Pat. No. 5,634,055. Again, these applications are limited to interaction within a specific company and are not designed to allow competition from outside the company.

Although secured transactions using PIN numbers have been applied often to financial matters, as in U.S. Pat. No. 5,524,073, such security has not been necessary in automated and/or computerized employment scheduling, as these matters have heretofore been confined to same-company or in-house transactions.

None of the prior art lends itself to facilitate scheduling by hospitals and medical facilities of temporary personnel, on short notice, within a secure system, that is completely automated through web-based servers.

### SUMMARY OF THE INVENTION

The invention provides a process wherein computer software is used to facilitate the assignment of medical registry personnel to staff medical facilities on short notice as needed. Hospital and other medical facilities use temporary staffing to cover shifts where there own workers call in sick or are on vacation. These temporary medical staffers are obtained from registries, which are similar to temporary employment agencies but are distinguished by the fact that they place only licensed medical personnel, such as physicians, nurses and respiratory therapists. Currently, the procedure for obtaining registry personnel is for the hospital supervisor to telephone one or more registries until they have located a person to fill a shift vacancy. As can be expected, the system breaks down when hospital staffers who are assigned to evening or night shifts call in sick a few hours before their shift is to start. Only a handful of registries operate 24 hours a day, seven days a week. Failure to obtain registry personnel for critical departments in the hospital such as neonatal intensive care and emergency room can leave the facility ill-equipped to provide expected levels of service to the community. The process presented here “computerizes” the process so that the same level of availability exists 24 hours a day, seven days a week, without the labor-intensiveness of the present system. Through the use of the software proposed herein, the hospital may place the order into the system by a data entry clerk. The software then sorts the database for available personnel and transmits a message by hardwire or wireless communications directly to several potential registry staffers within the hospital's geographical area. The software continues to make contacts until one of the registry staffers returns the computer contact and “accepts” the shift. This process completely eliminates the manual telephonic inquiries and communications between the hospitals and the registries, and between the registries and their staffers. This invention further allows shifts to be filled without regard to whether there is anyone present in the registry office, since the computerized contact is made directly to the staffer, apprising him of the shift request. Thus, the registry may provide 7 day, 24 hour service to its hospitals without any increase in office staffing. This invention includes a billing function which automatically bills the hospital from the registry for each staffer supplied, using the information contained in the order and the permanent database.

Objects and Advantages

This invention contains several objects and advantages over prior methods of medical scheduling, including but not limited to:

(a) allowing a hospital to enter its request for a specific shift and a particular medical discipline a single time electronically over a secure website, as opposed to their current practice of telephoning a number of registries with the order, each of which must then telephone its inventory of staffers to see if a match can be made within the short time before the shift is to begin;

(b) allowing a hospital to immediately and automatically search the entire database for available staffers, thereby increasing the likelihood that the shift will be filled on short notice;

(c) allowing a hospital to obtain staffers for evening or night shifts on short notice when the registry offices are often closed;

(d) allowing a hospital to know immediately who has accepted the shift and to be able to access and verify their credentials electronically;

(e) allowing all registry personnel serving a particular hospital to have equal opportunity to accept a shift assignment without concern as to which registry was called “first”, as the electronic search reaches across company boundaries to all staffers in the database nearly simultaneously;

(f) allowing a potential staffer to access the order from the hospital electronically to receive the details of the assignment 24 hours per day, 7 days a week, from any location;

(g) allowing the billing from the registry to the hospital to be automated based on the data input from the ordering hospital and the “accepting” staffer, and the information contained in the permanent database.

Still further objects and advantages will become apparent from the ensuing description and drawings.

### DRAWING FIGURES

The drawings consist of three figures containing flowcharts, which figures may be laid end to end in pagination order to allow one to see the entire system from beginning to end.

FIG. 1 shows steps 1 through 5 in the system.

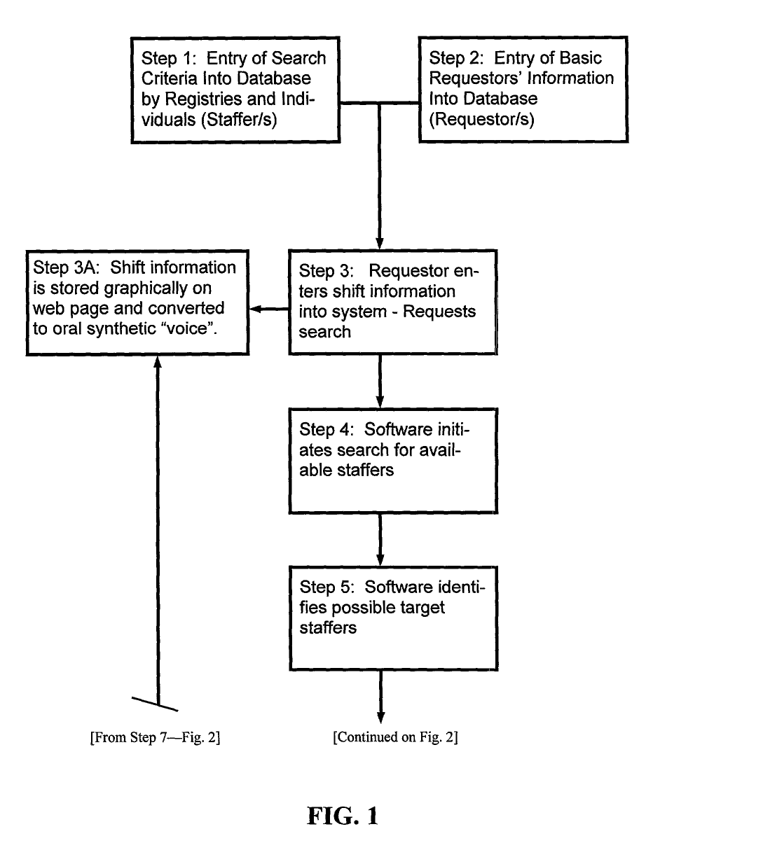

FIG. 2 shows steps 6 through 9 in the system.

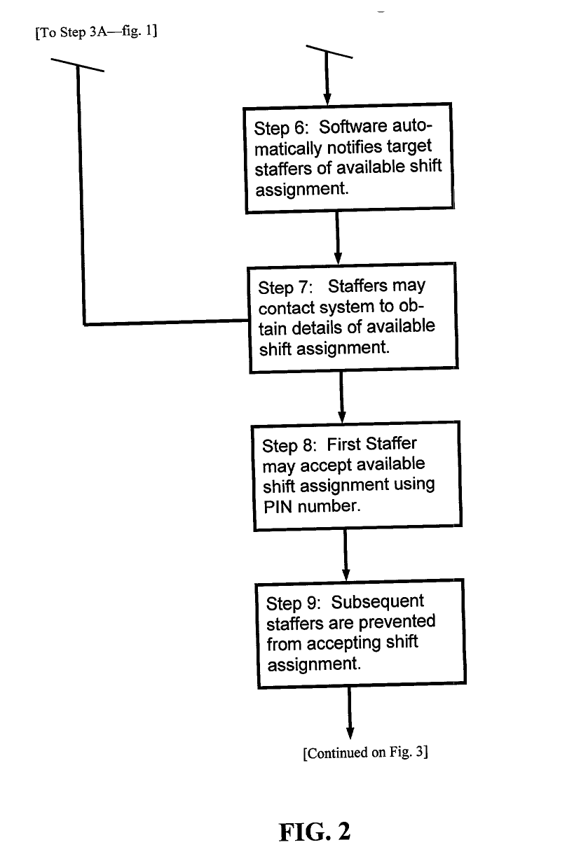

FIG. 3 shows steps 10 and 11 in the system.

### REFERENCE NUMERALS IN DRAWINGS

Step 1 Entry of search criteria into a permanent storage database by registries and individuals (staffers' search criteria).

Step 2 Entry of basic Requestors' information into a permanent storage database (Requestor/s identification information).

Step 3 Requestor enters shift information into system requests search.

Step 3A Shift information is stored graphically on accessible web page(s) and converted to oral synthetic “voice.”

Step 4 Software initiates search for available staffers.

Step 5 Software identifies possible target staffers.

Step 6 Software automatically notifies target staffers of available shift assignment.

Step 7 Staffer may contact system to obtain details of available shift assignment.

Step 8 First staffer may accept available shift assignment using PIN number.

Step 9 Subsequent staffers are prevented from accepting shift assignment.

Step 10 Requestor is notified by e-mail message that shift assignment was accepted and by whom.

Step 11 (Optional) System invoices Requestor for services of accepting Staffer.

### DETAILED DESCRIPTION OF THE PREFERRED EMBODIMENTS

Step 1 consists of the initial data entry by the registries of the search criteria of their respective staffers using a personal or network computer terminal which can access the Internet. The search criteria will include personal information about the “Staffer”. This includes but is not limited to the staffer's name, address, telephone number(s), e-mail address, certificates, licenses and credentials, areas of specialization, and other medical protocols customary to a particular discipline. The data entered will also include scheduling availability for each staffer, including but not limited to preferred shift times and dates. Step one is performed at the time a registry comes on-line with the system, but may be updated from time to time as staffers are added or deleted from the central database. Availability and calendaring information would be facilitated by drop-down lists on the web page(s) to enable the system to be user-friendly. In the unusual circumstance that a staffer wishes to be available for temporary employment by a hospital, but is not affiliated with a registry, that staffer may register his or her own information as an independent employee of the system operator. This same independent registration procedure would be used for staffers who live in areas where no registry exists. Each staffer is assigned an individual PIN number for accessing the system once they have been accepted by the system operator.

Step 2 consists of pre-registration of the hospitals and medical facilities who will be the “Requestors”. These users will be supplied with the software to enable them to enter their staffing requirements into the system using personal or network computer terminals which have access to the Internet to request staffing of particular shifts at their facility. Drop-down lists will be used to facilitate the entry of their information and they will also be assigned a PIN number to allow authorized personnel in their organization to place orders in the system. Once steps 1 and 2 are complete the users are ready to enter into transactions via the system.

Step 3 consists of the entry of a staffing order into the system by the Requestor hospital or medical facility. The authorized data entry clerk at the hospital merely selects from drop-down lists in order to place the order. These drop-down lists enable the clerk to select the discipline, such as nurse, physician, or respiratory therapist, as well as specialty, such as OR (operating room), ER (emergency room), OB (obstetrics), ICU (intensive care), Neonatal (infant intensive care), etc. The clerk will also indicate the date and times of the shift desired. The software will automatically verify and record the identity of the Requestor when the Requestor's PIN number is entered to access the system. Once the clerk has selected the search criteria, the order is sent into the system to the server operator.

Step 3A consists of the software creating a graphic display of the information contained in the order from the Requestor that can be viewed by any interested Staffer with a PIN number to access the system via the Internet. The software will also convert the displayed information digitally into a synthetic “voice” message that allows an interested staffer to obtain the order information by wireless or hard-wire telecommunications equipment.

Step 4 consists of the software initiating a search of the staffer database to find matches to the ordering criteria. This step is started automatically when the order is sent to the system by the Requestor.

Step 5 consists of the system software prioritizing the matches starting with all 100% matches. Matches of less than 100% of the search criteria entered by the Requestor will be given a proportionately lower priority and will be used by the system only if none of the Staffers with a 100% match respond within a given time frame. Of the staffers that are identified by a 100% match, the system may further prioritize these geographically by the commuting distance to the Requestor's facility.

Step 6 consists of the software initiating contact with the selected staffers that matched the search criteria. The contacts are initiated on a priority basis starting with those staffers that were a 100% match with the Requestor's order. The contact is made by a software initiated automatic telephone dialing system, whereby the system calls the selected staffers at the telephone numbers entered into the database during step 1. If a geographic priority was entered as part of the order due to short time constraints, the automatic dialer will prioritize the dialing sequence accordingly. The software may be configured to dial a hardwired or wireless telephone number, or a pager number. Additionally, the hardware may be configured to send an E-mail notification in addition to, or instead of, any of the other notification methods. The automatic dialing continues through all of the matching staffers until the entire list of matches has been notified of the available shift assignment at the Requestor's facility.

Step 7 consists of allowing the staffers who were contacted by the automatic dialer to retrieve the specific information about the assignment. By dialing a predesignated telephone number from their telephone, and using their PIN number to access the system, the staffer will receive enough synthesized voice information about the assignment to make a decision on acceptance. If the staffer is near a computer terminal at the time of the telephonic contact, the staffer may log onto the web site and view the assignment details graphically. Both the graphic and synthesized voice methods for delivering the information to interested staffers was automatically created by the software system in step 3A at the time the order was entered.

Step 8 consists of allowing a staffer to accept the shift assignment by entering his PIN number, the order number, and a preassigned acceptance code. This acceptance may be accomplished either through the touchpad of a telephone device following recorded prompts for entry of each set of numbers, or directly onto the web page containing the order by typing the correct code numbers on the computer keyboard. The accepting staffer will receive a graphic acknowledgment if using a keyboard or tonal acknowledge if using a telephone keypad that his acceptance of the designated shift assignment has been processed and entered into the system.

Step 9 consists of the software locking out further acceptance from any subsequent staffer. Only the first properly coded acceptance is retained by the system. The lockout is initiated automatically as soon as the first staffer has committed to acceptance of the assignment. Concurrently with the lockout of further acceptance, the automatic dialer, if still in the notification mode, is disengaged and further notifications are automatically suspended.

Step 10 consists of the software system automatically notifying the Requestor that a staffer has accepted the shift assignment. The notification is made by electronic mail (E-mail) and will contain the identity of the accepting staffer, along with a telephone number in case the Requestor wants to further confirm the acceptance directly with the accepting staffer. At this time, the Requestor may also verify the accepting staffer's credentials, licenses, and other protocols by accessing the permanent database constructed in step 1 with its PIN access number.

Step 11 consists of the software system using the information supplied by the two parties to the transaction, and the information supplied in steps 1 and 2, to create and send an invoice on behalf of the registry for the work completed by their staffer to the Requestor hospital or medical facility. The registry will have the option of having the invoice printed for mailing or sent directly to the Requestor's accounting office by E-mail.

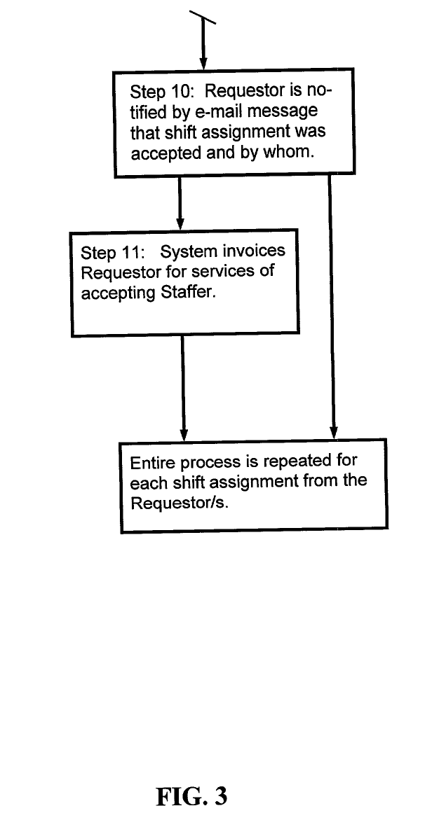

As shown in FIG. 3, after completion of step 11, the entire process may be repeated for each available shift that the Requestor wishes to enter into the system.

Additional Embodiments

While the preferred embodiment presents the complete invention in its ideal form, additional embodiments exist which include only one of two or more options available for some of the steps in the process. Accordingly, Step 3A could be modified to allow only one method of accessing the shift information, rather than two (graphic and synthetic voice). Additionally, Step 6 could allow notification by one, two, three, all four, or any combination of the four possible methods (hardwired telephone, wireless telephone, pager, E-mail) of notification presented in the preferred embodiment.

Alternative Embodiments

There are a number of alternative embodiments that would allow the system to be used by other industries with little modification to the software. For example, the system could be used by shippers to notify independent truckers of the availability of a shipment for transport. Once the users are entered into the system in Steps 1 and 2, the shipper would become the Requestor and enter the order into the system (Step 3). The drop-down lists would allow the shipper to describe the load and provide pertinent information such as origination point and destination. Step 4 would allow the software to initiate the search to match truckers with the load type and geographical proximity. Step 5 would identify the most likely truckers by looking for the highest percentage matches, and prioritize a list by proportionate percentage of matches. The automatic dialing would commence in Step 6 to notify those truckers that were targeted by the database search. The truckers would be able to access the system to obtain the particulars of the available load in Steps 7 and 3A. The first trucker may accept the assignment with his PIN number and acceptance code as in Step 8. Subsequent truckers would be locked out from accepting the order as in Step 9. The shipper would be notified by E-mail of the identity of the trucker who has accepted the shipping assignment (Step 10). The trucker could elect to have the shipping charges automatically billed to the shipper by the system (Step 11). The process could be repeated by the shipper for each load that it has.

While this is but one example of application of the system to other than the medical staffing industry, an embodiment would ensue under any business condition where “the Requestor would be able to directly contact competing vendors simultaneously for their acceptance of an assignment for the scheduling of services to be performed at a pre-determined price.”

Accordingly, those skilled in the art will appreciate that many additions, modifications, and substitutions are possible without departing from the scope or spirit of the invention as defined in the accompanying claims.

Advantages

This invention contains several advantages over prior methods of medical scheduling, including but not limited to:

(a) allowing a hospital to enter its request for a specific shift and a particular medical discipline a single time electronically over a secure website, as opposed to their current practice of telephoning a number of registries with the order, each of which must then telephone its inventory of staffers to see if a match can be made within the short time before the shift is to begin;

(b) allowing a hospital to immediately and automatically search the entire database for available staffers, thereby increasing the likelihood that the shift will be filled on short notice;

(c) allowing a hospital to obtain staffers for evening or night shifts on short notice when the registry offices are often closed;

(d) allowing a hospital to know immediately who has accepted the shift and to be able to access and verify their credentials electronically;

(e) allowing all registry personnel serving a particular hospital to have equal opportunity to accept a shift assignment without concern as to which registry was called “first”, as the electronic search reaches across company boundaries to all staffers in the database nearly simultaneously;

(f) allowing a potential staffer to access the order from the hospital electronically to receive the details of the assignment 24 hours per day, 7 days a week, from any location;

(g) allowing the billing from the registry to the hospital to be automated based on the data input from the ordering hospital and the “accepting” staffer, and the information contained in the permanent database.

Conclusion

Accordingly, the reader may see that the invention provides many distinct advantages over present scheduling systems. The present state of the art in automated scheduling restricts access to in-house application through proprietary software use. Likewise, the limitations are readily apparent in systems which merely allow customers to “post” an order or request on a web-page. Similarly, limitations exist in systems which allow an order to be placed only with one vendor when time is of the essence.

This invention eliminates these and other inherent problems by creating a system where the order is proactively and affirmatively sent to many pre-selected vendors nearly simultaneously, allowing the first vendor who responds to accept and thereby obtain the order.

With respect to the preferred embodiment for use in the temporary medical staffing industry, no such electronic scheduling system currently exists.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

I claim:

1. A system for scheduling medical professionals from medical registries to perform temporary shift assignments at hospitals and medical facilities using the Internet comprising the steps of:
(a) means for allowing entry by a registry of the search criteria information for their medical staffers into a storage area of said system using personal or network computer terminals which are enabled to access the Internet;
(b) means for allowing entry by a user hospital of identification information into said storage area of said system using said personal or network computer terminals which are enabled to access the Internet;
(c) means for allowing entry by said user hospital of specifics of an order for a shift assignment;
(d) means for allowing automatic search through said storage areas by said system for possible matches between said order and said stored data referred to by subsection (a);
(e) means for allowing identification and prioritization by said system of matches between said stored data and said order;
(f) means for allowing automatic notification by said system of matching staffers in priority order on a continuous basis until completed or suspended;
(g) means for allowing access to said order specifics in said system by said medical staffers using a PIN number, which specifics are available graphically or by synthetic voice accessed by telecommunications or other electronic means;
(h) means for allowing a staffer who has been notified by said system to electronically accept said order using said PIN number;
(I) means for allowing said system to lock out subsequent attempts to accept said order using a PIN number from another staffer;
(j) means for allowing said system to notify said user-hospital of the identity of said accepting staffer by electronic means; and
(k) means for allowing said system to invoice user-hospital on behalf of registry for services of staffer accepting the shift assignment using information from said order, said acceptance, and from said storage areas of said system.

2. The system of claim 1, wherein the system contains means whereby entries are made into said storage area of said system using preprogramed drop-down lists.

3. The system of claim 1, wherein said system contains means for said entries to be made into said storage area of said system by data entry from a standard computer keyboard of any brand name.

4. The system of claim 1, wherein said system contains means whereby said notification is accomplished by said system by automatically dialing a hard-wire telephone number for said matching staffers.

5. The system of claim 1, wherein said system contains means whereby said notification is accomplished by said system by automatically dialing a wireless telephone number for said matching staffers.

6. The system of claim 1, wherein said system contains means whereby said notification is accomplished by said system by automatically dialing a pager number for said matching staffers.

7. The system of claim 1, wherein said system contains means whereby said notification is accomplished by said system by automatically sending an electronic mail message to an E-mail address for matching staffers.

8. The system of claim 1, wherein said system contains means whereby said medical staffers may access said order information graphically, using a personal computer of any brand with Internet access capability.

9. The system of claim 1, wherein said system contains means whereby said medical staffers may access said order information stored in electronic synthetic digital voice.

10. The system of claim 1, wherein said system contains means whereby said medical staffers may accept shift assignments by hardwired telecommunications, using a PIN number.

11. The system of claim 1, wherein said system contains means whereby said medical staffers may accept shift assignments by wireless telecommunications, using said PIN number.

12. The system of claim 1, wherein said system contains means whereby said medical staffers may accept shift assignments by E-mail, using said PIN number.

13. The system of claim 1, wherein said system contains means that automatically notifies an ordering hospital by E-mail of the identity of an accepting medical staffer.

14. The system of claim 1, wherein said system contains means that automatically notifies said ordering hospital by digital synthetic voice message of the identity of said accepting medical staffer.

15. The system of claim 1, wherein said system contains means whereby invoices created by said system may be printed for physical mailing.

16. The system of claim 1, wherein said system contains means whereby invoices created by said system may be sent to said ordering hospital by E-mail.

17. The system of claim 1, wherein said system contains means whereby funds may be transferred automatically and electronically by the system to complete a billing cycle.

18. The system of claim 1, wherein said system contains means whereby any requesting business could transmit its order to several pre-sorted vendors nearly simultaneously wherein the first said vendor who correctly responds could accept and obtain the order.
